(19) United States
(12) Patent Application Publication
(10) Pub. No.: US 2007/0274299 A1
(43) Pub. Date: Nov. 29, 2007

(54) Methods, computer programs, and apparatus for providing emergency number compliant VoIP devices

(76) Inventor: John Ruckart, Atlanta, GA (US)

Correspondence Address: CANTOR COLBURN LLP - BELLSOUTH, 55 GRIFFIN ROAD SOUTH, BLOOMFIELD, CT, 06002, US

(21) Appl. No.: 11/433,501

(22) Filed: May 12, 2006

(51) Int. Cl. H04L 12/66

(52) U.S. Cl. 370/356

(57) ABSTRACT

An emergency number compliant device is capable of implementing a VoIP call from a registered geographic location with access to an emergency services operator. A power source applied to the device is detected, and an automated prompt is issued asking if a user of the device is at the registered geographic location.

### CROSS REFERENCE TO RELATED APPLICATIONS

This application is related to the following commonly assigned patent applications:

U.S. patent application Ser. No. 10/024,135, filed Dec. 21, 2001, entitled “SYSTEM AND METHOD FOR VOICE OVER INTERNET PROTOCOL USING A STANDARD TELEPHONE SYSTEM”, by John P. Ruckart and Rimas Rauba, the disclosure of which is incorporated by reference herein in its entirety.

United States Publication No. US2005-0232243, filed May 20, 2005, entitled “Voice-over Network (VoN)/Voice-over Internet Protocol (VoIP) architect using advance intelligent network alternatives”, by Maria Adamczak et al., the disclosure of which is incorporated by reference herein in its entirety.

United States Publication No. US2005-0047574, filed Sep. 2, 2003, entitled “Methods, apparatus and computer program products for routing phone calls to a PSTN or a packet switched network based on called number”, by Laura Reid, the disclosure of which is incorporated by reference herein in its entirety.

U.S. patent application Ser. No. 11/321,094, filed Dec. 29, 2005, entitled “Method and System for Control of a Voice/Data Communications Device using a Radio Frequency Component”, by Bambi F. Walters and Scott P. Zimmerman, the disclosure of which is incorporated by reference herein in its entirety.

U.S. patent application Ser. No. 11/318,110, filed Dec. 23, 2005, entitled “METHODS, SYSTEMS, and COMPUTER PROGRAM PRODUCTS FOR PROVIDING LOCATION INFORMATION FOR VOIP EMERGENCY CALLING”, by Tingting Lu, the disclosure of which is incorporated by reference herein in its entirety.

### BACKGROUND

This disclosure relates generally to telephony, and more particularly, to voice communications carried over the Internet.

Voice over Internet Protocol (VoIP) is a technology that enables telephone calls to be placed using a broadband Internet connection. Whereas some VoIP providers limit calls to others using the same service, most VoIP providers enable calls to be placed to any telephone number including local, long distance, international, or mobile numbers. VoIP providers may require the use of specialized customer premises equipment, such as a computer coupled to a microphone and headset, a special VoIP phone, or a plain ordinary telephone set (POTS phone) coupled to an analog telephone adaptor.

In the case of POTS phones and adaptors, calls are placed by connecting the adaptor to a high-speed Internet connection, picking up the phone, and dialing a telephone number assigned to a called party. The call is routed through a local telephone carrier to a VoIP provider. The VoIP provider routes the call over the Internet to the called party's local telephone company for completion of the call. If a computer and a microphone handset are used to implement a VoIP call, the call is dialed using a keyboard. The call is routed through a cable modem or DSL connection to the Internet. If a wireless device is used to implement a VoIP call, the device establishes a connection with the Internet over a wireless broadband link. Regardless of the type of customer premises equipment used to place a VoIP call, the call recipient does not need to utilize any special equipment, and may receive the call using a standard POTS phone.

At present, millions of customers in the United States subscribe to VoIP providers as a substitute for traditional landline phone service. Pursuant to the terms of many VoIP plans, subscribers may place calls of any desired duration to any destination throughout the world for a fixed monthly fee. Moreover, VoIP plans typically provide teleconferencing features at no extra cost, thereby permitting several people at several different locations to converse with each other at the same time.

One significant shortcoming of existing VoIP providers is inconsistent access to local emergency operators. In the United States, 911 has been designated as the emergency telephone number to be used by the public to summon aid or to report a crime, fire or accident to a local emergency operator. By dialing 911, a caller is provided with single-number access to any of a plurality of emergency authorities, such as the police, fire department, ambulance, hospital, bomb squad, animal control, or the like. These authorities are accessed through trained local emergency operators based upon the nature of the emergency. In this manner, prompt contact with the proper authority is facilitated when the caller is impaired or under stress.

VoIP customers have a reasonable expectation that their VoIP phones will operate as conventional telephones during an emergency whereby, in response to dialing an emergency number such as 911, a customer will automatically be connected to a local emergency operator. However, some VoIP providers do not offer any access to emergency operators, and other VoIP providers only offer access to local emergency operators for customers situated in certain areas of the country. A few VoIP services route incoming 911 calls from customers to a centralized location that may be situated in a distant city and staffed by administrative personnel who are not trained to handle emergency situations. Even if a VoIP provider offers access to local emergency operators, customers must first register their location with the VoIP provider so as to ensure access to the appropriate local emergency 911 (E-911) service. In view of the foregoing factors, VoIP customers who dial 911 in an emergency will not always be able to reach a local emergency services operator.

Because some VoIP providers do not routinely connect their customers to local emergency operators, public safety officials across the United States have been unable to address certain calls for help in a timely fashion, resulting in several tragedies. Accordingly, the Federal Communications Commission (FCC) has adopted an E911 Order setting forth new requirements applicable to all IP-enabled service providers in the United States. For further details, refer to “IP-Enabled Services; E911 Requirement for IP-Enabled Service Providers, First Report and Order and Notice of Proposed Rulemaking”, WC Docket Nos. 04-36, 05-196, FCC 05-116, released May 19, 2005, hereinafter referred to as the “E911 Order”. Briefly, the E911 Order requires VoIP providers to deliver all 911 calls to the customer's local emergency operator as a standard feature. VoIP providers must provide emergency operators with a customer's call back number and location information upon the customer dialing 911. Although the customer is responsible for providing location information to the VoIP provider, the VoIP provider must offer the customer a means of updating this information.

Presently existing VoIP customer premises equipment does not achieve the foregoing functionalities required by the E911 Order. Moreover, the FCC has not set forth technical details governing the manner in which such equipment may achieve compliance with the E911 Order. One significant shortcoming of existing equipment is that, while the equipment is readily transported from one location to another, the VoIP provider will always assume that the customer is at his or her registered location. Although the customer has the option of updating the registered location, customers may not always perform this update, especially if they are going on a business trip or vacation followed by a return to the registered location.

Existing customer premises equipment will function at any location served by a high speed Internet connection, but dialing 911 will access the local emergency operator serving the registered location even if the equipment is not currently deployed at the registered location. For example, assume that a VoIP subscriber uses customer premise equipment in the form of a POTS phone and an analog telephone adapter. The subscriber normally uses the phone and adapter at his residence in New York City but, on occasion, brings this equipment along on business trips to California. Although the subscriber has registered his home address with the VoIP provider, he is staying at a hotel room in Los Angeles when an emergency arises. He dials 911 on the POTS phone, whereupon the analog telephone adapter establishes a connection to the VoIP provider via a high-speed Internet connection. The VoIP provider looks up the subscriber's registered location and routes the call to an emergency operator in New York City. However, since the emergency is taking place in Los Angeles, precious time is lost. In view of the foregoing shortcomings, what is needed is a mechanism by which the location of VoIP customer premises equipment is updated so as to permit a call placed to 911 to be routed to a local emergency operator.

### BRIEF SUMMARY

Embodiments include methods for providing an emergency number compliant device to be used to implement a VoIP call at a registered geographic location with access to an emergency services operator. These methods include detecting a power source being applied to the device, and issuing an automated prompt asking if a user of the device is at the registered geographic location.

These methods can also be viewed as providing computer program products for establishing a trusted network. The computer program products include a storage medium readable by a processing circuit and storing instructions for execution by the processing circuit for facilitating a method of providing an emergency number compliant device to be used to implement a VoIP call at a registered geographic location with access to an emergency services operator. These methods include detecting a power source being applied to the device, and issuing an automated prompt asking if a user of the device is at the registered geographic location.

Embodiments also include a VoIP device capable of providing access to an emergency services operator from a registered geographic location. The device comprises a detection mechanism for detecting a power source being applied to the device, and an output mechanism, responsive to the detection mechanism detecting a power source being applied to the device, for issuing an automated prompt asking if a user of the device is at the registered geographic location.

Other methods, apparatus, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF DRAWINGS

Referring now to the drawings wherein like elements are numbered alike in the several FIGURES:

FIG. 1 is a block diagram showing a VoIP system constructed according to various illustrative embodiments;

FIGS. 2A-2B together comprise a flowchart depicting methods for providing E911-compliant analog telephone adapters according to a first set of illustrative embodiments; and

FIGS. 3A-3B together comprise a flowchart depicting methods for providing E911-compliant VoIP software according to a second set of illustrative embodiments.

The detailed description explains exemplary embodiments of the invention, together with advantages and features, by way of example with reference to the drawings.

### DETAILED DESCRIPTION OF EXEMPLARY EMBODIMENTS

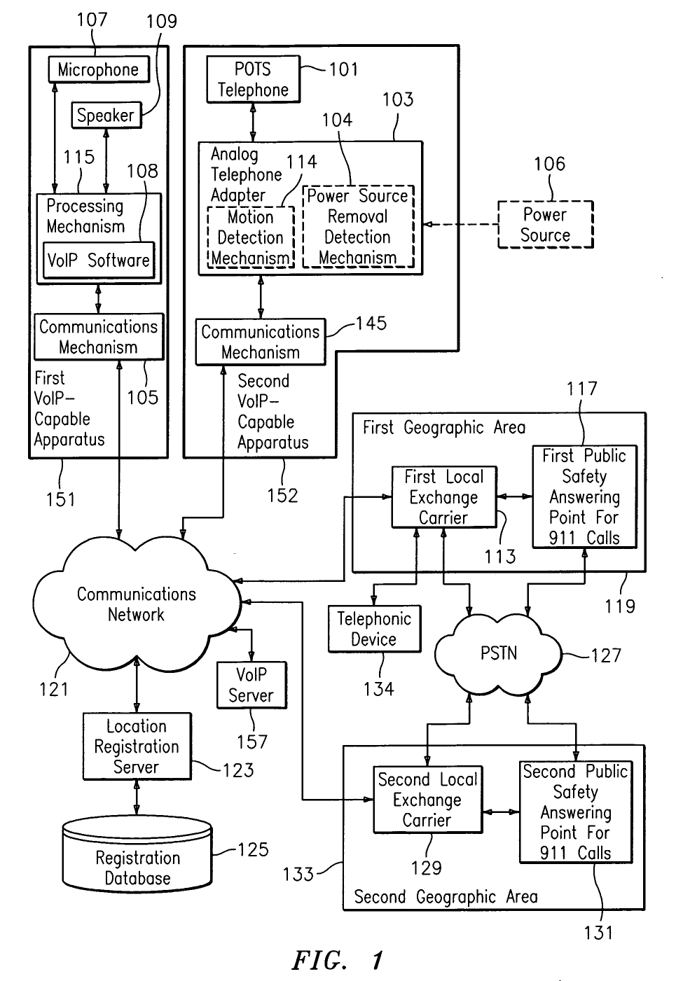

FIG. 1 is a block diagram showing a Voice over Internet Protocol (VoIP) communication system constructed according to various illustrative embodiments. Illustratively, the VoIP communication system includes a first VoIP-capable apparatus 151 and a second VoIP-capable apparatus 152. First VoIP-capable apparatus 151 may represent customer premises equipment used by a first VoIP user/customer, and second VoIP-capable apparatus 152 may represent customer premises equipment used by a second VoIP user/customer. It should be appreciated that although the term “customer” is used in the following description for ease of explanation, the invention is applicable to any user of a VoIP capable apparatus, whether that user is the actual customer that has subscribed to the VoIP service or not.

First VoIP-capable apparatus 151 includes a microphone 107 and a speaker 109 coupled to a processing mechanism 115. Microphone 107 is capable of transforming acoustical energy into electrical signals, and speaker 109 is capable of transforming electrical signals into acoustical energy. Optionally, microphone 107 and speaker 109 may be provided in the form of a handset worn by a user. Alternatively or additionally, microphone 107 and speaker 109 may be integrated into a single element that functions as both a microphone and a loudspeaker. Processing mechanism 115 is equipped to execute VoIP software 108. VoIP software enables first VoIP-capable apparatus 151 to implement a VoIP call. Processing mechanism 115 may, but need not, be implemented using a personal computer (PC), mainframe computer, workstation, laptop, palm pilot, wireless device, or microprocessor-based device.

Processing mechanism 115 is coupled to a communications mechanism 105 capable of communicating with a communications network 121 such as the Internet or a private Intranet. Communications mechanism 105 represents any device capable of communicating with a VoIP server 157 over a high-speed internet protocol (IP) connection. Illustrative implementations of communications mechanism 105 include a broadband modem, an Ethernet card, a wireless transceiver, or any of various combinations thereof.

Second VoIP-capable apparatus 152 includes a plain ordinary telephone set (POTS) telephone 101 coupled to an analog telephone adapter 103. Analog telephone adapter 103 is coupled to a communications mechanism 145 capable of communicating with communications network 121. As was the case with communications mechanism 105, communications mechanism 145 represents any mechanism capable of communicating with VoIP server 157 over a high-speed IP connection. Illustrative implementations of communications mechanism 145 include a broadband modem, an Ethernet card, a wireless device, or any of various combinations thereof. Analog telephone adapter 103 is implemented using any apparatus capable of interfacing a telephonic device to communications mechanism 145. Analog telephone adapter 103 may be equipped with a first port for connection to POTS telephone 101 and a second port for connection to communications mechanism 145. Optionally, analog telephone adapter 103 is equipped to perform analog-to-digital conversion, whereupon the adapter may communicate directly over the Internet without the need for a separate communications mechanism 145.

By way of example, one possible implementation of analog telephone adapter 103 includes a first port in the form of one or more RJ-11 jacks to which a telephone and/or fax may be connected, and a second port in the form of a USB connector that plugs into a desktop computer, laptop computer, or handheld computing device. The various functionalities of this exemplary analog telephone adapter 103 may be provided using software, such as a softphone program. Effectively, this software acts as an intermediary between POTS telephone 101 and VoIP server 157, digitizing voice data so that it can be transmitted over the Internet.

Another illustrative implementation of analog telephone adapter 103 may be employed in an enterprise setting. Analog telephone adapter 103 is equipped with multiple jacks to which a plurality of telephones and/or fax machines may be connected, as well as an RJ-45 connection to which a 10/100BaseT Ethernet hub or switch may be connected. The Ethernet hub or switch is used to connect analog telephone adapter 103 to a local area network (LAN). Such an analog telephone adapter 103 may digitize voice data, using protocols such as such as H.323 or SIP to communicate directly with VoIP server 157, such that softphone software is not required. An analog telephone adapter 103 that connects telephones to a LAN is sometimes referred to as a VoIP gateway.

Regardless of the specific manner in which analog telephone adapter 103 is implemented, the adapter includes a relocation determination mechanism for determining whether it has been moved from one location to another. Illustratively, this relocation determination mechanism is implemented using at least one of a motion detection mechanism 114 or a power source removal detection mechanism 104. Analog telephone adapter 103 may, but need not, be powered using an external power source 106 such as household current. If household current is used to supply power for analog telephone adapter 103, power source removal detection mechanism 104 is equipped to detect at least one of power source 106 being removed from analog telephone adapter 103 (i.e., being unplugged from the wall), or power source 106 being reapplied to analog telephone adapter 103 (i.e., being plugged in) after a subsequent removal. In this manner, power source removal detection mechanism 104 is triggered whenever a VoIP customer unplugs analog telephone adapter 103 from power source 106, subsequently travels to a new location, and then plugs the adapter into another power source at this new location.

Alternatively or in addition to power source removal detection mechanism 104, analog telephone adapter 103 may include a motion detection mechanism 114 for determining whether the adapter has been relocated from one location to another. Motion detection mechanism 114 may include one or more tilt sensors, mercury switches, reed switches or the like. Accordingly, relocation of analog telephone adapter 103 may be detected in situations where the adapter is powered solely by its own internal battery.

Communications network 121 is coupled to a first local exchange carrier 116 serving a first geographic area 119 and a second local exchange carrier 129 serving a second geographic area 133. First local exchange carrier 116 and second local exchange carrier 129 are each capable of establishing communication links over a public switched telephone network (PSTN) 127.

First geographic area 119 is served by a first public safety answering point (PSAP) for 911 calls 117, and second geographic area 133 is served by a second public safety answering point (PSAP) for 911 calls 131. First PSAP for 911 calls 117 represents a physical location where 911 emergency telephone calls originating from first geographic area 119 are routed over PSTN 127 to an appropriate local emergency service, such as a police or fire department serving the first geographic area 119. Second PSAP for 911 calls 131 represents a physical location where 911 emergency telephone calls originating from second geographic area 133 are routed over PSTN 127 to an appropriate local emergency service, such as a police or fire department serving the second geographic area 131.

A VoIP registration server 123 is in communication with communications network 121. VoIP registration server 123 maintains a registration database 125 of VoIP customers setting forth location information for each of a plurality of VoIP customers. More specifically, registration database 125 associates each of a plurality of VoIP customer identifiers uniquely identifying a specific VoIP customer with location information received from that customer. When a VoIP customer dials 911, a notification signal identifying the VoIP customer is sent over communications network 121 to VoIP registration server 127. VoIP registration server 127 uses registration database 125 to retrieve location information corresponding to the identified customer. The retrieved location information is then utilized by VoIP registration server 127 to identify a PSAP serving that location, such as first public safety answering point for 911 calls 117 or second public safety answering point for 911 calls 131. VoIP registration server 127 then causes the 911 call to be routed to the identified PSAP.

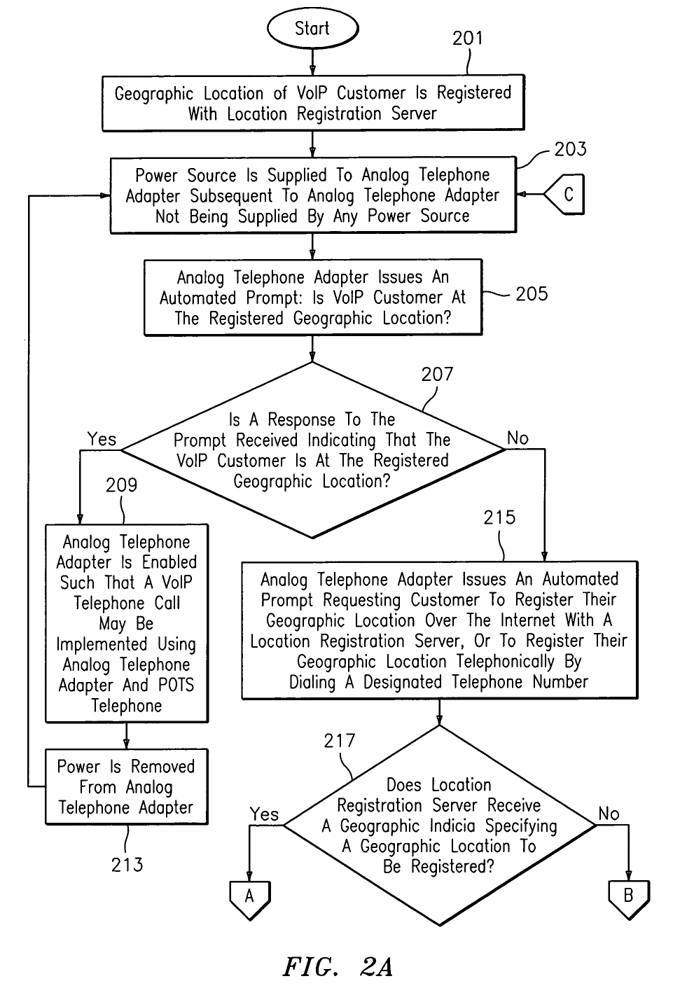

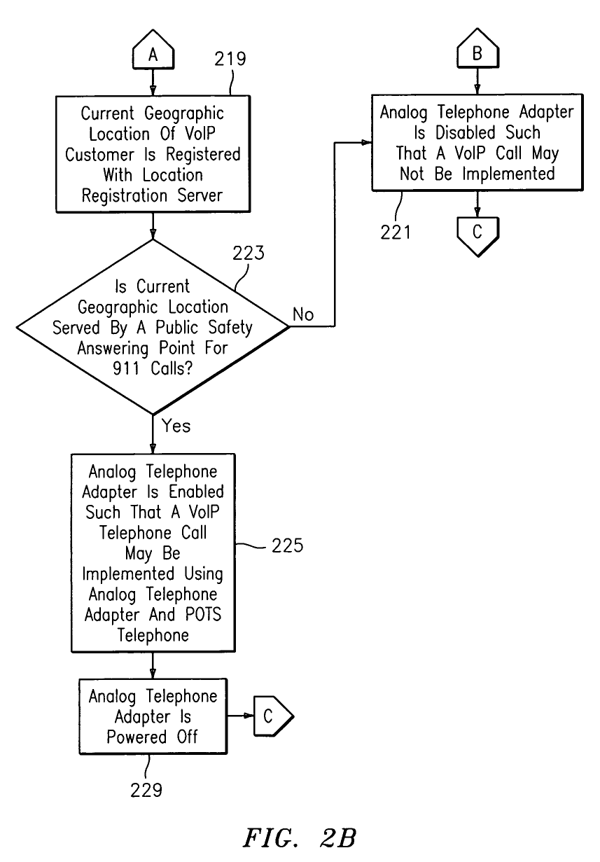

FIGS. 2A-2B together comprise a flowchart depicting methods for providing E911-compliant analog telephone adapters according to a first set of illustrative embodiments. These methods may be performed, for example, in conjunction with second VoIP-capable apparatus 152 (FIG. 1). The program commences at block 201 (FIG. 2A) where the geographic location of a VoIP customer is registered using location registration server 123 (FIG. 1) to update registration database 125. Illustratively, this step is performed by the customer accessing registration server 123 over the Internet using a computing device, whereupon registration server 123 accepts information from the customer indicative of the customer's location and uses this information to update registration database 125. Alternatively or additionally, registration database 125 is updated by the customer placing a telephone call to a designated telephone number, whereupon a customer services representative uses location registration server 123 to update registration database 125, or whereupon the customer's caller identification information is utilized to automatically determine the customer's geographic location and automatically update registration database 125.

At block 203 (FIG. 2A), second VoIP-capable apparatus 152 (FIG. 1) detects application of a power source 106 to analog telephone adapter 103. Illustratively, detection of power source 106 is performed subsequent to VoIP-capable apparatus 152 not being supplied by any power source. For the sake of illustration, power source 106 may comprise a standard wall outlet, in which case analog telephone adapter 103 is furnished with a plug for insertion into the wall outlet. Accordingly, block 203 (FIG. 2A) may be performed by removing this plug from a first wall outlet and inserting the plug into a second wall outlet, wherein the first and second wall outlets could, but need not, be situated at different geographic locations. Note that a removal of power from the analog telephone adapter (FIG. 2A, block 203) followed by resumption of power may, but need not, be indicative of a customer changing their location. For example, the power interruption of block 203 may signify that a customer has unplugged the analog telephone adapter to pack it on a trip. Alternatively, this power interruption could signify that the customer has merely moved analog telephone adapter 103 from his bedroom to his living room, such that the adapter remains at the registered geographic location which, in this example, is the customer's home.

At block 205, the analog telephone adapter issues an automated prompt to the VoIP customer asking whether or not the VoIP customer is at the registered geographic location. Next (block 207), a test is performed to determine whether or not a response to the automated prompt is received indicating that the VoIP customer is at the registered geographic location. If the VoIP customer is at the registered geographic location, program control progresses to block 209 where the analog telephone adapter is enabled such that a VoIP call may be implemented using the analog telephone adapter and POTS telephone 101 (FIG. 1). At block 213 (FIG. 2A), power is removed from the analog telephone adapter, and program control loops back to block 203.

The negative branch from block 207 leads to block 215 where the analog telephone adapter issues an automated prompt requesting the customer to register their geographic location with location registration server 123 (FIG. 1) over the Internet. Alternatively or additionally, the automated prompt may instruct the customer to place a telephone call to a designated telephone number, whereupon a customer service representative uses location registration server 123 to update registration database 125, or whereupon the customer's caller identification information is utilized to automatically determine the customer's geographic location and automatically update location registration database 125. At block 217 (FIG. 2A), a test is performed to ascertain whether or not the location registration server receives a geographic indicia specifying a geographic location to be registered. If not, the analog telephone adapter is disabled at block 221 (FIG. 2B), for example by automatically shutting the adapter off (. Program control then loops back to block 203.

The affirmative branch from block 217 leads to block 219 (FIG. 2B) where the current geographic location of the customer is registered with the location registration server. At block 223, a test is performed to ascertain whether or not the current geographic location is served by a public safety answering point for 911 calls. If not, the program advances to block 221 where the analog telephone adapter is disabled. The affirmative branch from block 223 leads to block 225 where the analog telephone adapter is enabled so as to permit a VoIP call to be implemented using the adapter and a POTS telephone. At block 229, the analog telephone adapter is powered off, and program control returns to block 203 (FIG. 2A).

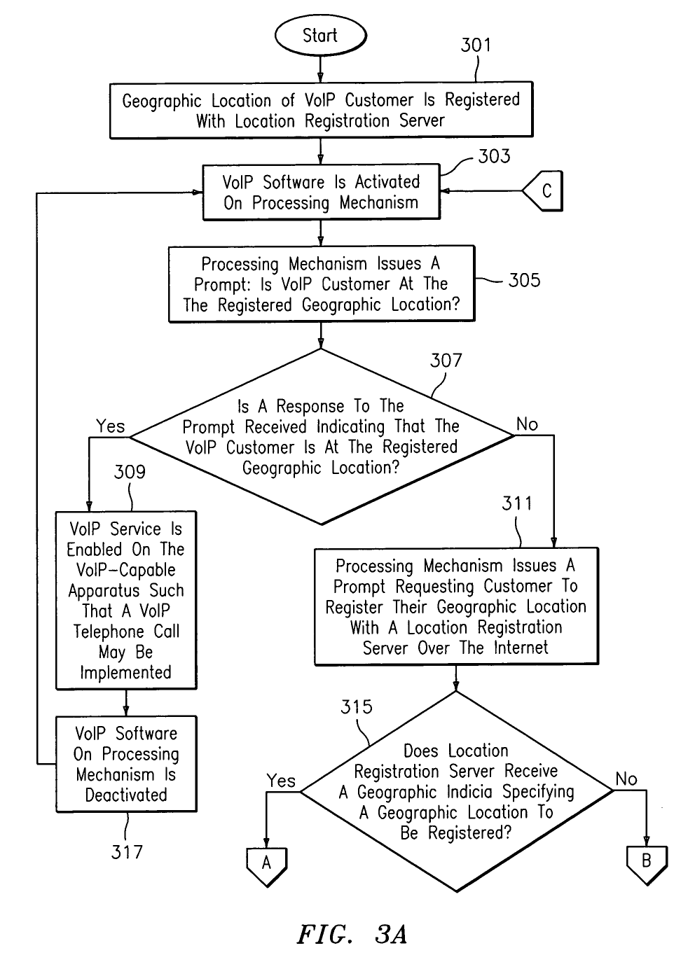

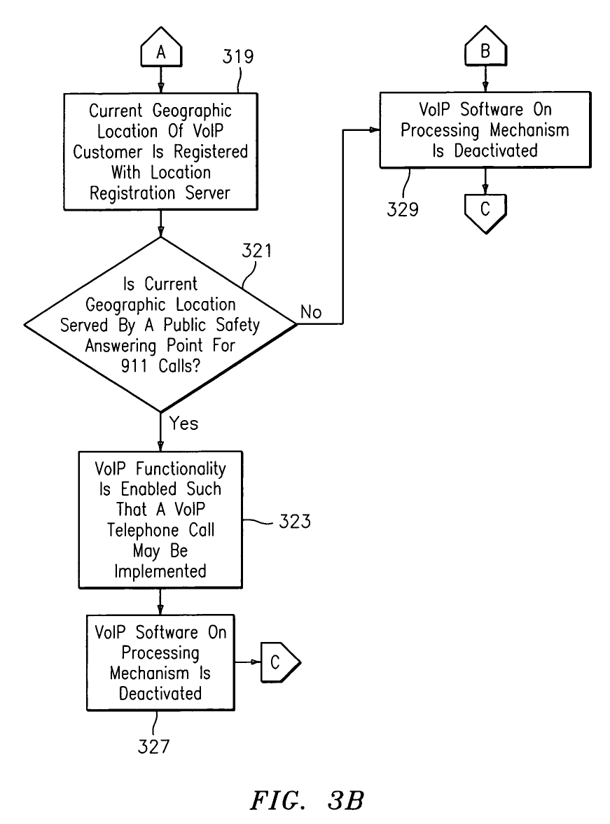

FIGS. 3A-3B together comprise a flowchart depicting methods for providing E911-compliant VoIP software according to a second set of illustrative embodiments. These methods may be performed, for example, in conjunction with first VoIP-capable apparatus 151 (FIG. 1). At block 301 (FIG. 3A), the geographic location of a VoIP customer is registered using location registration server 123 (FIG. 1) to update registration database 125. This step may be performed, for example, by the customer accessing the location registration server over the Internet, alternatively or additionally, registration database 125 is updated by the customer placing a telephone call to a designated telephone number, whereupon a customer services representative uses location registration server 123 to update registration database 125, or whereupon the customer's caller identification information is utilized to automatically determine the customer's geographic location and automatically update registration database 125.

Next (FIG. 3A, block 303), VoIP software (FIG. 1, 108) is activated on processing mechanism 115. The processing mechanism issues a prompt (FIG. 3A, block 305): Is the VoIP customer at the registered geographic location? At block 307, a test is performed to determine whether or not a response to the prompt has been received indicating that the customer is at the registered geographic location. If not, the processing mechanism issues a prompt requesting the customer to register their geographic location with the location registration server over the Internet (block 311). Alternatively or additionally, the customer is instructed to register their geographic location by placing a telephone call to a designated telephone number, whereupon a customer services representative uses the location registration server to update the registration database, or whereupon the customer's caller identification information is utilized to automatically determine the customer's geographic location and automatically update the registration database.

From block 311, program control progresses to block 315 where a test is performed to determine whether or not the location registration server receives a geographic indicia specifying a geographic location to be registered. If not, the program advances to block 329 (FIG. 3B) where VoIP software on the processing mechanism is disabled, such that a VoIP call cannot be placed. This step may be performed, for example, by programming the VoIP software to self-deactivate. The program then loops back to block 303. The affirmative branch from block 315 leads to block 319 (FIG. 3B) where the current geographic location of the VoIP customer is registered with the location registration server. A test is performed at block 321 to determine whether or not the current geographic location is served by a public safety answering point for 911 calls. If not, the program loops back to block 329 (described previously). The affirmative branch from block 321 leads to block 323 where the VoIP software enables VoIP functionality, such that a VoIP call may be implemented using first VoIP-capable apparatus (FIG. 1, 151). At block 327 (FIG. 3B), after a VoIP telephone call is terminated, the VoIP software is deactivated (illustratively, the user may deactivate the software or it may be programmed to self-deactivate), and the program loops back to block 303 (FIG. 3A).

As described above, the present invention can be embodied in the form of computer-implemented processes and apparatuses for practicing those processes. The present invention can also be embodied in the form of computer program code containing instructions embodied in tangible media, such as floppy diskettes, CD ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. For example, while the description above is directed to 911 calls, it should be appreciated that the invention may be applicable to other dedicated emergency numbers. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A method for providing an emergency number compliant device to be used to implement a VoIP call at a registered geographic location with access to an emergency services operator, the method comprising:
detecting a power source being applied to the device, and
issuing an automated prompt asking if a user of the device is at the registered geographic location.

2. The method of claim 1, wherein a public safety answering point (PSAP) provides the device at the registered location with access to an E911 emergency services operator.

3. The method of claim 1, further comprising receiving a response indicating that the user is at the registered geographic location, and enabling VoIP functionality so as to permit one or more VoIP calls to be placed.

4. The method of claim 3, further comprising placing a VoIP call to 911 and thereby accessing a local emergency services operator for the registered geographic location.

5. The method of claim 1, further comprising disabling VoIP functionality if a response indicating that the user is at the registered geographic location is not received, such that a VoIP call cannot be placed.

6. The method of claim 5, further comprising issuing an automated prompt instructing the user to register their current geographic location.

7. The method of claim 6, further comprising providing information indicative of the user's present geographic location to a location registration server.

8. The method of claim 7, wherein the information is used to update a registration database that associates each of a plurality of respective identifiers specifying a VoIP user with a corresponding geographic identifier specifying a registered geographic location.

9. The method of claim 8, wherein the information comprises caller identity information indicative of the current geographic location of the user.

10. The method of claim 8, wherein the information is provided via a website.

11. A computer program product for establishing a trusted network, the computer program product comprising:
a storage medium readable by a processing circuit and storing instructions for execution by the processing circuit for facilitating a method of providing an emergency number compliant device to be used to implement a VoIP call at a registered geographic location with access to an emergency services operator, the method comprising:
detecting a power source being applied to the device, and
issuing an automated prompt asking if a user of the device is at the registered geographic location.

12. The computer program product as recited in claim 11, wherein a public safety answering point (PSAP) provides the device at the registered location with access to an E911 emergency services operator.

13. The computer program product as recited in claim 11 wherein, if the device receives a response indicating that the user is at the registered geographic location, the instructions enable VoIP functionality so as to permit the device to be used for placing one or more VoIP calls.

14. The computer program product as recited in claim 11 wherein the instructions enable a VoIP call to be placed to 911 to thereby access a local emergency services operator for the registered geographic location.

15. The computer program product as recited in claim 11 further including instructions wherein, if the device does not receive a response indicating that the user is at the registered geographic location, a VoIP call cannot be placed.

16. The computer program product as recited in claim 15 further comprising instructions for issuing an automated prompt instructing the user to register their current geographic location.

17. The computer program product as recited in claim 16 further comprising instructions for receiving information at a location registration server indicative of the user's present geographic location.

18. The computer program product as recited in claim 17 further comprising instructions for using the received information to update a registration database, wherein the registration database associates each of a plurality of respective user identifiers specifying a VoIP user, with a corresponding geographic identifier specifying a registered geographic location.

19. The computer program product as recited in claim 17 wherein the received information comprises caller identity information indicative of the current geographic location of the user.

20. The computer program product of claim 17 wherein the received information is received by a website.

21. The computer program product of claim 20 wherein the received information updates the registration database using a location registration server.

22. A VoIP device capable of providing access to an emergency services operator from a registered geographic location, the device comprising:
a detection mechanism for detecting a power source being applied to the device, and
an output mechanism, responsive to the detection mechanism detecting a power source being applied to the device, for issuing an automated prompt asking if a user of the device is at the registered geographic location.

23. The VoIP device of claim 22 further comprising an input mechanism operatively coupled to a processing mechanism, wherein the input mechanism is capable of receiving a response indicating that the user is at the registered geographic location and, in response thereto, the processing mechanism enables VoIP functionality so as to permit one or more VoIP calls to be placed.

24. The VoIP device of claim 23 wherein the processing mechanism is programmed to disable VoIP functionality if the input mechanism does not receive a response indicating that the user is at the registered geographic location, such that a VoIP call cannot be placed.

25. The VoIP device of claim 24 wherein, if VoIP functionality is disabled, the processing mechanism is programmed to activate the output mechanism to issue an automated prompt instructing the user to register their current geographic location.
